(19) United States
(12) Patent Application Publication
(10) Pub. No.: US 2016/0201709 A1
(43) Pub. Date: Jul. 14, 2016

(54) RIVET WITH CUTTING MANDREL TIP AND ONE-SIDED JOINING METHOD

(71) Applicants: GM Global Technology Operations LLC, Detroit, MI (US); THE REGENTS OF THE UNIVERSITY OF MICHIGAN, ANN ARBOR, MI (US)

(72) Inventors: YONGQIANG LI, ROCHESTER, MI (US); JUNYING MIN, BOCHUM (DE); BLAIR E. CARLSON, ANN ARBOR, MI (US); SHIXIN JACK HU, ANN ARBOR, MI (US)

(21) Appl. No.: 14/978,817

(22) Filed: Dec. 22, 2015

Related U.S. Application Data
(60) Provisional application No. 62/102,883, filed on Jan. 13, 2015.

(51) Int. Cl. F16B 19/08; B21J 15/02; F16B 19/10

(52) U.S. Cl. CPC F16B 19/086; F16B 19/1027; B21J 15/025; F16B 2019/1009

(57) ABSTRACT

A product and method for fastening workpiece elements. A rivet assembly may include a mandrel with a cutting edge that forms an opening in the workpiece elements as the rivet body is positioned through the workpiece elements.

### CROSS REFERENCE TO RELATED APPLICATIONS

This application claims benefit of U.S. Provisional Application No. 62/102,883 filed Jan. 13, 2015.

### TECHNICAL FIELD

The field to which the disclosure generally relates includes fastening, and in particular includes fastening where access to the workpiece is limited to one side.

### BACKGROUND

Manufactured products are typically assembled from a number of components that are integrated into a product. The individual elements may be engaged in a number of fashions, one of which involves being fastened together. The options for fastening elements together are copious. However, the challenges in joining parts of an assembly are endless and the need for new and effective devices and methods of fastening persists.

### SUMMARY OF ILLUSTRATIVE VARIATIONS

A number of illustrative variations may involve a product for fastening elements and may include a rivet body that has a hollow shank with an opening of a first diameter. A mandrel may extend through the shank. The mandrel may have a segment extending out of the shank that has a second diameter that is greater than the first diameter. The segment may terminate in a cutting edge.

In other illustrative variations, a method may be involved for one sided joining of multiple workpieces. A first workpiece element may be provided and at least a second workpiece element may be positioned adjacent the first workpiece element at a location for fastening the elements together. A rivet assembly may be positioned in a machine. The rivet assembly may include a rivet body that has a shank and a head. A mandrel may extend through the rivet body and may have an edge configured to cut. The machine may be operated to rotate the rivet assembly and to translate the rivet assembly toward the workpiece elements. An opening may be cut through the workpiece elements by the edge and simultaneously the shank and the mandrel may be positioned through the opening. The mandrel may be drawn out of the opening expanding the shank to fasten the multiple workpiece elements together.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a partial cross sectional illustration of a rivet with cutting mandrel tip according to a number of variations.

FIG. 2 is a graph of force in kilonewtons versus rivet displacement in millimeters for penetrating and fastening according to a prior art example and a number of variations.

FIG. 3A is a schematic illustration of a step in a one sided joining method according to a number of variations.

FIG. 3B is a schematic illustration of a step in a one sided joining method according to a number of variations.

FIG. 3C is a schematic illustration of a step in a one sided joining method according to a number of variations.

FIG. 3D is a schematic illustration of a step in a one sided joining method according to a number of variations.

FIG. 4A is a schematic illustration of a step in a one sided joining method according to a number of variations.

FIG. 4B is a schematic illustration of a step in a one sided joining method according to a number of variations.

### DETAILED DESCRIPTION OF ILLUSTRATIVE VARIATIONS

The following description of the variations is merely illustrative in nature and is in no way intended to limit the scope of the invention, its application, or uses.

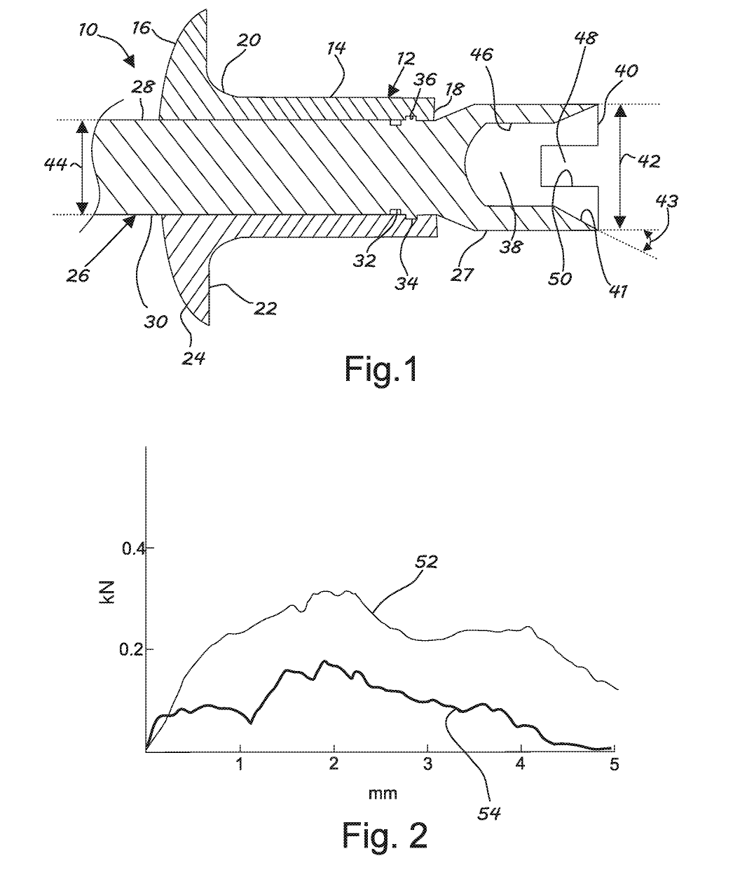

In assembly, one of the challenges in efficient fastening of components involves limited access to the individual elements that are intended to be secured together. When elements are positioned together so that access can be gained to only one side of the stacked elements, the effective options of available fastening methods are greatly reduced. One such application may involve large sheet components, which may be positioned together with multiple overlapping edges that are in need of being secured. To successfully connect such elements, a rivet assembly 10 with a cutting mandrel tip as illustrated in FIG. 1 may be provided according to a number of variations.

The rivet assembly 10 may include a rivet body 12, which may include a shank 14 and a head 16. The shank 14 may be formed in a hollow cylindrical shape with a length selected to extend through the thickness of the elements to be secured together so that the leading end 18 will extend out of the elements when the shank 14 is positioned in an opening through the elements. The head 16 may extend radially outward around the end 20 of the shank 14. The head 16 may include a substantially flat or concave annular surface 22 facing in the direction of the shank 14, and may include a curved or convex surface 24, opposite the surface 22. The shapes of surfaces 22 and 24 may be varied to fit the workpiece and profile or appearance desired for the application.

The rivet assembly 10 may include a mandrel 26 that may extend through the rivet shank 14 and that may have a general shape of a cylindrical rod with a tip section 27. The mandrel 26 may include a segment 28 that extends out of the shank 14 and away from the surface 24 a distance sufficient to connect with a machine for imparting rotary action and force. The segment 28 may include annular grooves around its outer surface or other features for engaging with the chuck of the selected machine. A reduced diameter section 32 may be provided in the mandrel 26 at a location where breakoff from the tip section 27 is preferred. In addition, an enlarged diameter section 34 may be provided in the mandrel 26 near the tip section 27 that may clip into a groove 36 in the interior of the rivet shank 14 near the end 18. The section 34 may provide a mechanism for securing the mandrel 26 in the rivet body 12 prior to use, in a manner that may facilitate feeding into the machine that applies the rivet assembly 10 to a workpiece.

The tip section 27 may be presented extending out of the rivet body 12 and away from end 18 of the rivet shank 14 and may have a diameter 42 that is larger than the diameter 44 of the segment 28, and is larger than the internal open diameter of the shank 14. The tip section 27 may include a cavity 38 opening through the end 40 so that an annular wall 46 is formed around the cavity 38. The cavity may preferably have a depth that is greater than the diameter 42 to facilitate cutting. A cutting edge may be provided at the end 40 with an angled section 41 tapering toward the end 40, or may otherwise be sharpened. The section 41 may be tapered at an angle 43 to facilitate cutting and chip formation, which may be thirty degrees.

A number of slots 48 may be formed around the diameter of the annular wall 46 that open through the end 40. The number of slots 48 may be two or more, and may more preferably be between three and six. The slots may facilitate cutting action and may provide clearance for the escape of displaced workpiece material such as chips, through the wall 46. In addition, the leading edge 50 in the slot 48 may be sharpened to facilitate cutting. The slot 48 may have a depth from the end 40 toward the rivet body 12 that is greater than the stacked thickness of the workpiece components that the mandrel 26 is intended to penetrate. This ensures that the slot remains open during the entire cutting process. The width of the slot 48 across the end 40 may be selected based on the material to be cut

The rivet assembly 10 may be employed to cut through the workpieces to be fastened, providing itself an opening within which the rivet body 12 may then act as a fastener. FIG. 2 graphically illustrates a comparison of the penetration forces between a known friction stir blind riveting operation using a standard rivet at curve 52 and a rivet with cutting mandrel tip at curve 54 according to a number of variations described herein as rivet assembly 10. The graph charts forces in kilonewtons along the vertical axis as applied toward the workpiece to be penetrated, and penetration distance in millimeters of the workpiece along the horizontal axis. The workpiece used to develop the graph is comprised of two stacked sheets of aluminum alloy with a top sheet being AA6111 at 1.0 millimeter thickness, and a bottom sheet being AA6022 with a 2.0 millimeter thickness. The significant reduction in required force provided by the rivet assembly 10 means that one sided joining of thinner gauge sheet materials may be accomplished without the need of a counter-acting die or support, which cannot be done through competing piercing and joining methods. The lower required forces may result in less deformation of the workpieces.

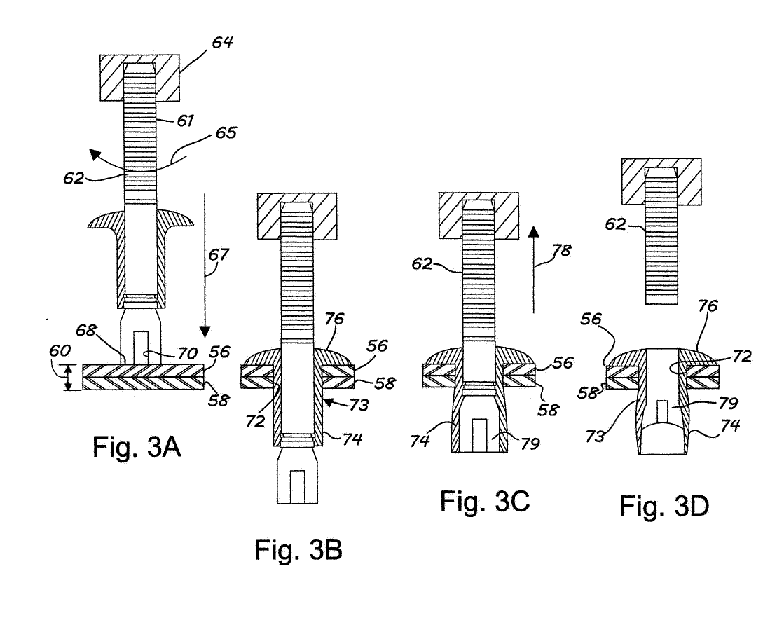

Referring to FIGS. 3A through 3D, the process steps of a one sided joining method using the rivet assembly 10 are illustrated. In FIG. 3A, a workpiece is provided consisting of two stacked sheets 56 and 58 that are intended to be fastened together having a total thickness 60 of 1.8 millimeters. A mandrel 61 of a rivet assembly 62 is mounted in a machine 64 that imparts a rotational input 65 and a translational feed rate 67 directed toward the workpiece. The cutting tip 68 includes a number of slots 70 that have a depth into the mandrel 61 from tip 68 that is greater than the total thickness 60. The rotating tip 68 is pressed against the workpiece at a feed rate (that may be constant or variable to facilitate cutting), or force (that may be constant of variable to facilitate cutting), and cuts through the sheets 56 and 58 forming an opening 72 completely through the sheets 56, 58 as shown in FIG. 3B.

With the cutting action complete as illustrated in FIG. 3B, the rivet shank 74 of rivet body 73 is positioned through the opening 72 and extends out past sheet 58 with the head 76 positioned against the sheet 56. The head 76 may be held against sheet 56 and the mandrel may be withdrawn as illustrated in FIG. 3C with an upsetting force 78 applied to the mandrel 62 away from the workpiece. The segment 79 expands the shank 74 as it is drawn through, and locks the sheets 56 and 58 together. The mandrel 62 is then broken as shown in FIG. 3D and the rivet body 73 remains in place fastening sheets 56 and 58 between the head 76 and expanded shank 74. The segment 79 remains in the rivet body 73 and within the opening 72. The sheets 56 and 58 are joined with improved surface quality of the sheet 56 and advantageous cross tension strength between the sheets 56 and 58. The thickness 60 of the sheets 56 and 58 to be joined may include a bottom sheet 58 with a thickness of less than 2.0 millimeters. The method can be used to join multiple sheets. When joining two or more sheets from one side, the deformation in the unsupported sheet in particular that is penetrated by the cutting edge last must be limited. The lower normal force by using the cutting mandrel 62 is most advantageous in this situation.

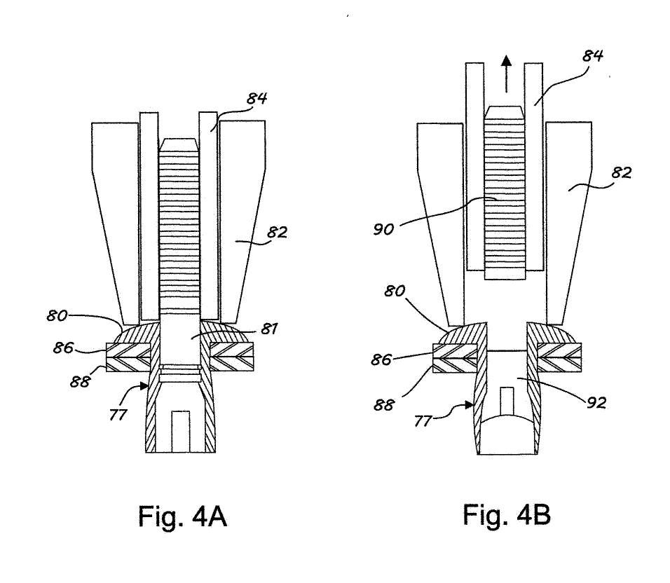

Referring to FIGS. 4A and 4B a mandrel breaking process according to a number of variations is illustrated. In FIG. 4A a rivet body 77 is shown inserted into an opening cut through workpiece elements 86 and 88. The rivet is held in place by a machine with outer collar 82 which engages the head 80 of the rivet. An inner collar 84 is received within the outer collar 82 and engages the mandrel 81. The inner collar 84 may impart a rotating force to mandrel 81 to cut through the workpiece elements 86, 88, which in the illustration has already occurred. As shown in FIG. 4B, as the outer collar 82 holds the rivet down, the inner collar 84 may apply a tensile force to the mandrel 81 to break the mandrel 81 separating the stem 90 from the cutting head 92. The mandrel breaking force is balanced within the rivet assembly and no lateral force is applied upon the workpieces, avoiding unintended deformation of the workpiece elements 86, 88.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may involve a product for fastening elements and may include a rivet body that has a hollow shank with an opening of a first diameter. A mandrel may extend through the shank. The mandrel may have a segment extending out of the shank that has a second diameter that is greater than the first diameter. The segment may terminate in a cutting edge.

Variation 2 may include a product according to variation 1 wherein a cavity may be formed in the segment that opens through the cutting edge.

Variation 3 may include a product according to variation 2 wherein the segment may include a wall disposed around the cavity with at least one slot formed in the wall through the cutting edge.

Variation 4 may include a product according to variation 3 wherein the elements may have a total thickness, and wherein the slot may have a depth that is greater than the total thickness.

Variation 5 may include a product according to any of variations 1 through 4 wherein the mandrel may include a segment with an enlarged diameter that is disposed in the shank to retain the mandrel in the rivet body prior to fastening of the elements.

Variation 6 may include a product according to any of variations 1 through 5 wherein the cutting edge may be formed by an angle of approximately thirty degrees.

Variation 7 may include a product according to any of variations 1 through 6 wherein the elements include an last element that is penetrated last by the cutting edge, wherein the last element may have a thickness less than 2.0 millimeters.

Variation 8 may involve a rivet assembly for fastening multiple elements. The rivet assembly may include a rivet body that may have a hollow shank with a first end and an opposite second end. The rivet body may have a head with a first surface of the head facing the shank and a second surface of the head facing away from the shank. A mandrel may extend through the rivet body. The mandrel may have a first segment extending out of the rivet body beyond the second surface. The mandrel may have a second segment extending out of the rivet body on an opposite side of the rivet body from the first segment. The second segment may terminate at a cutting edge that is formed at an acute angle.

Variation 9 may include a product according to variation 8 wherein a cavity may extend into the second segment and may open through the cutting edge defining a wall around the cavity.

Variation 10 may include a product according to variation 9 wherein a slot may be formed in the wall through the cutting edge.

Variation 11 may include a product according to variation 10 or 11 wherein the slot may form a leading edge on the wall, wherein the leading edge may be sharpened.

Variation 12 may include a product according to variation 11 wherein the elements may have a total thickness and wherein the slot depth may be greater than the total thickness.

Variation 13 may include a product according to any of variations 8 through 12 wherein the cutting edge and the leading edge may be hardened.

Variation 14 may involve a method for one sided joining wherein multiple workpiece elements may be positioned adjacent one another at a location for fastening the multiple elements together. A rivet assembly may be positioned in a machine. The rivet assembly may include a rivet body that has a shank and a head. A mandrel may extend through the rivet body and may have an edge configured to cut. The machine may be operated to rotate the rivet assembly and to translate the rivet assembly toward the multiple workpiece elements. An opening may be cut through the multiple workpiece elements by the edge and simultaneously the shank and the mandrel may be positioned through the opening. The mandrel may be drawn out of the opening expanding the shank to fasten the multiple workpiece elements together.

Variation 15 may include a method according to variation 14 and may include the step of providing a slot in the mandrel that may be configured to allow material of the multiple workpiece elements cut by the edge to pass through the slot.

Variation 16 may include a method according to variation 14 or 15 and may include breaking the mandrel and leaving a segment of the mandrel with the edge in the rivet body and within the multiple workpiece elements.

The above description of select variations within the scope of the invention is merely illustrative in nature and, thus, variations or variants thereof are not to be regarded as a departure from the spirit and scope of the invention.

1. A product for fastening elements comprising:
a rivet body that has a hollow shank with an opening of a first diameter;
a mandrel extending through the shank, wherein the mandrel has a segment extending out of the shank that has a second diameter that is greater than the first diameter, the segment terminating in a cutting edge.

2. The product according to claim 1 wherein a cavity is formed in the segment and opens through the cutting edge.

3. The product according to claim 2 wherein the segment includes a wall disposed around the cavity with at least one slot formed in the wall through the cutting edge.

4. The product according to claim 3 wherein the elements have a total thickness and wherein the slot has a depth that is greater than the total thickness.

5. The product according to claim 1 wherein the mandrel includes a segment with an enlarged diameter that is disposed in the shank to retain the mandrel in the rivet body prior to fastening of the elements.

6. The product according to claim 1 wherein the cutting edge is formed by an angle of approximately thirty degrees.

7. The product according to claim 1 wherein the elements include a last element that is penetrated last by the cutting edge, wherein the last element may have a have a total thickness less than 2.0 millimeters.

8. A rivet assembly for fastening multiple elements, the rivet assembly comprising:
a rivet body that has a hollow shank with a first end and an opposite second end that has a head, with a first surface of the head facing the shank and a second surface of the head facing away from the shank;
a mandrel extending through the rivet body wherein the mandrel has a first segment extending out of the rivet body beyond the second surface, wherein the mandrel has a second segment extending out of the rivet body on an opposite side of the rivet body from the first segment, wherein the second segment terminates at a cutting edge that is formed at an acute angle.

9. The rivet assembly according to claim 8 wherein a cavity extends into the second segment and opens through the cutting edge defining a wall around the cavity.

10. The rivet assembly according to claim 9 wherein a slot is formed in the wall through the cutting edge.

11. The rivet assembly according to claim 10 wherein the slot forms a leading edge on the wall, wherein the leading edge is sharpened.

12. The rivet assembly according to claim 10 wherein the slot has a depth from the cutting edge, and the first and second elements have a total thickness, and wherein the depth is greater than the total thickness.

13. The rivet assembly according to claim 8 wherein the cutting edge is hardened.

14. A method for one sided joining comprising:
providing multiple workpiece elements;
positioning the multiple workpiece elements adjacent one another at a location for fastening the multiple workpiece elements together;
positioning a rivet assembly in a machine wherein the rivet assembly comprises a rivet body that has a shank and a head, with a mandrel extending through the rivet body, wherein the mandrel has an edge configured to cut;
operating the machine to rotate the rivet assembly and to translate the rivet assembly toward the multiple workpiece elements;
cutting an opening through the multiple workpiece elements with the edge and simultaneously positioning the shank and the mandrel through the opening;
drawing the mandrel out of the opening;
expanding the shank with the mandrel to fasten the multiple workpiece elements together.

15. The method according to claim 14 further comprising the step of providing a slot in the mandrel that is configured to allow material of the multiple workpiece elements that is cut by the edge to pass through the slot.

16. The method according to claim 14 further comprising the steps of breaking the mandrel; and leaving a segment of the mandrel with the edge in the rivet body and within the multiple workpiece elements.
